(19) United States
(12) Patent Application Publication
(10) Pub. No.: US 2026/0166777 A1
(43) Pub. Date: Jun. 18, 2026

(54) Drywall Mud Mixing Device

(71) Applicant: David A. Howard, McCalla, AL (US)

(72) Inventor: David A. Howard, McCalla, AL (US)

(21) Appl. No.: 19/462,718

(22) Filed: Jan. 28, 2026

Related U.S. Application Data
(63) Continuation-in-part of application No. 18/214,269, filed on Jun. 26, 2023, now Pat. No. 12,589,371.

(51) Int. Cl. B28C 9/00; B28C 5/12; B28C 5/16

(52) U.S. Cl. CPC B28C 9/004; B28C 5/1215; B28C 5/16

(57) ABSTRACT

A mixing device for use with an electric drill for mixing drywall mud, tile grout, concrete mixes and paint in various size containers and smaller applications. A mixing device is disclosed having a shaft, a central hub and mixing rods that are equidistant from each other and have a side vertical portion and a flat bottom portion such that the mixing device can efficiently mix all material that is on the sidewalls and bottom of a mixing container.

### CROSS-REFERENCED TO RELATED APPLICATIONS

The current application is a Continuation-in-Part application of Non-Provisional application Ser. No. 18/214,269 filed Jun. 6, 2023 and claims priority to application Ser. No. 18/214,269.

### FEDERALLY SPONSORED RESEARCH

None

### SEQUENCE LISTING

None

### FIELD OF THE INVENTION

The present invention relates to the drywall finishing industry. More specifically, the present invention relates to a drywall joint compound mixing device.

### BACKGROUND OF THE INVENTION

The installation of drywall in a structure requires a joint compound or drywall mud that is used to fill in seams between drywall panels and other imperfections such as nail divots, corners, and gaps between other sheets of drywall. Joint compound is a powder substance consisting primarily of gypsum dust and limestone. To form the drywall mud, water is mixed with the joint compound. Traditionally, this has been done by hand with a putty knife and drywall pan and is a very time-consuming process. There have been some improvements with mixing large quantities of joint compound with the use of rotating paddle mixers operated using an electric drill, however these rotating paddle mixers have several shortcomings. First, they cannot completely mix all of the joint compound powder located in the vessel due to the angles of a drywall mud vessel. Second, they cannot mix small quantities such as the type that would fit in a drywall mud pan. Third, these paddle mixers have a tendency to sling the drywall mud all around a space such that it creates a mess for an installer to clean up. Finally, and among other disadvantages, these prior art paddle mixers have to be cleaned by hand to prevent the joint compound from setting up and hardening on the paddle mixers. What is needed in the art is a drywall mud mixing device that is adaptable to smaller containers and can mix the dry joint compound that is found in corners, the bottom, and on sidewalls completely. Additionally, what is needed in the art is a drywall mud mixing device that can quickly and efficiently mix drywall mud in a non-messy manner and that can be cleaned very quickly.

### SUMMARY OF THE INVENTION

The invention disclosed is a drywall mud mixing device comprising a hexagonal shaft that is insertable into an electrical drill bit aperture. Located a distance down the shaft is a central hub that is attached to the shaft. The central hub has apertures on its bottom surface aligned in a circular pattern and said apertures have a depth that travels upward into the central hub. Insertable into said apertures are stainless steel rods. Said stainless steel rods are shaped such that they form a mixing shape that includes straight vertical sidewalls and a flat bottom such that the mixing device can mix joint compound powder located on the bottom of a flat mixing pan, corners of a mixing pan and flat sidewalls of a mixing pan. A bottom hub connects the terminal ends of the mixing rods in an equidistant arrangement of the mixing rods.

### BRIEF DESCRIPTION OF THE DRAWINGS

FIG. 1 is a perspective view of one embodiment of the mixing device.

FIG. 2 is a side elevation of one embodiment of the mixing device.

FIG. 3 is a bottom plan view of the central hub of the mixing device.

FIG. 4 is a perspective view of the bottom hub of the mixing device.

FIG. 5 is a bottom plan view of the mixing device.

FIG. 6 is a top plan view of the mixing device. (use FIG. 3 from first patent)

FIG. 7 is a side elevation of an alternate embodiment of the mixing device.

FIG. 8 is a bottom perspective view of an alternate embodiment of the invention.

FIG. 9 is a bottom plan view of an alternate embodiment of the mixing device.

FIG. 10 is a perspective view of the bottom hub top portion and bottom portion unassembled.

FIG. 11 is a perspective view of the mixing tool in use with a mud pan and drywall mud mixture.

FIG. 12 is a front plan view of a mixing rod.

### DETAILED DESCRIPTION

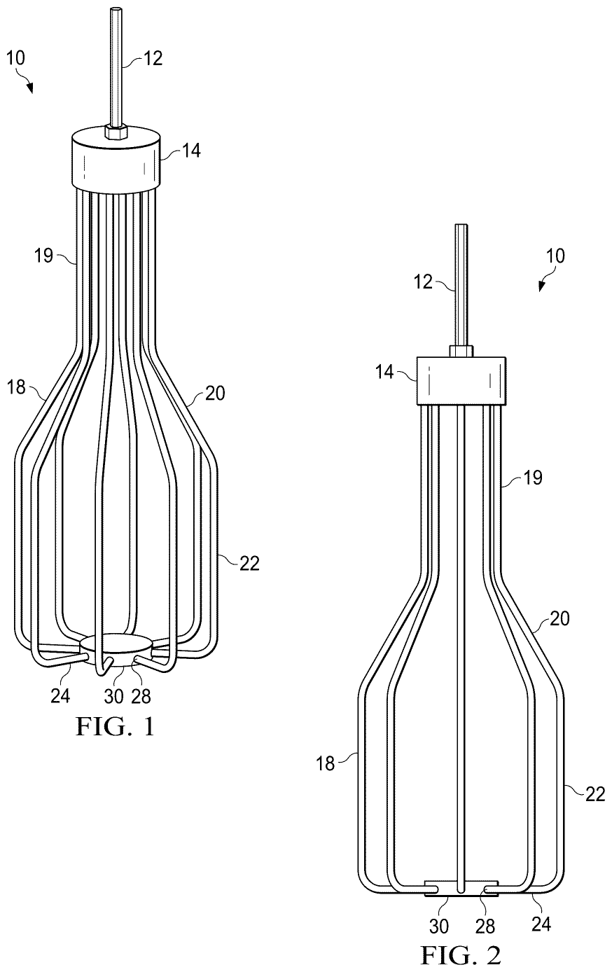

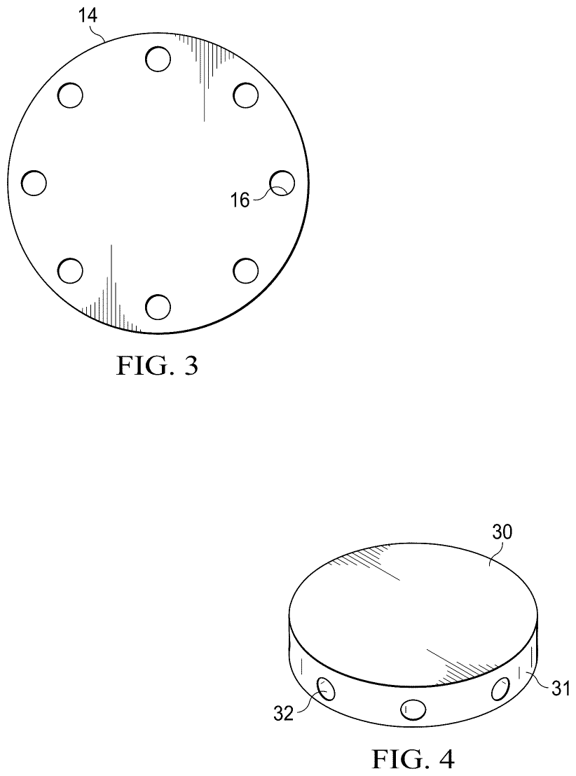

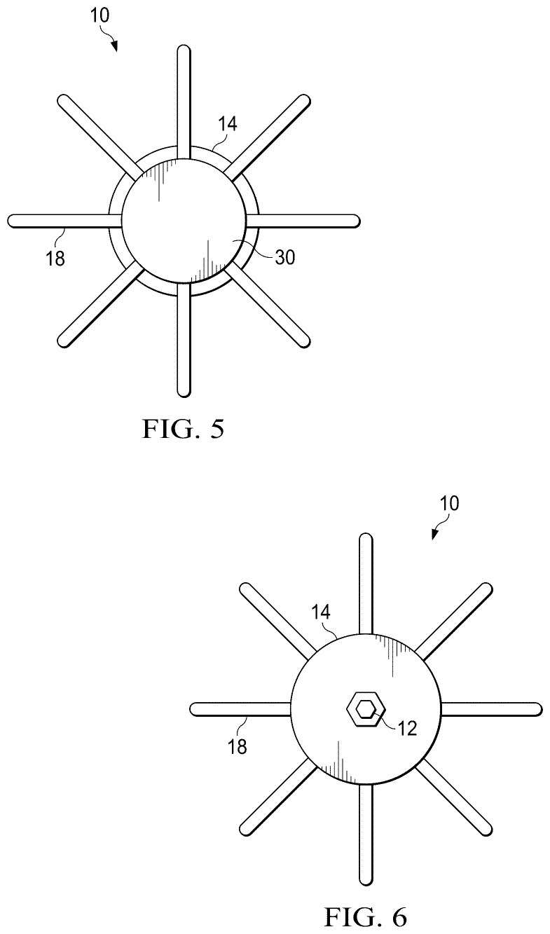

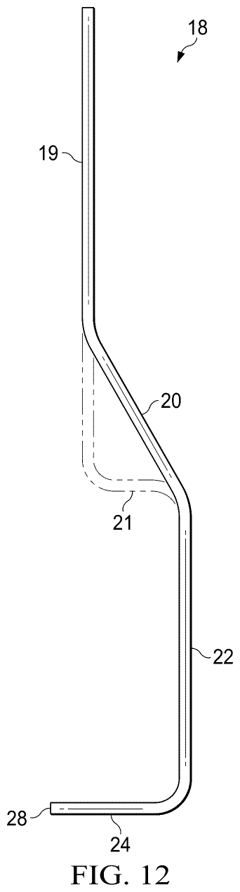

Referring now to FIGS. 1-6 there is shown one embodiment of the drywall mud mixing device 10 having a shaft 12 that is connected to a central hub 14. The shaft 12 in one embodiment is hexagonal in shape along its length and generally ½ inch wide. Referring to FIG. 3, located in the central hub 14 bottom surface are apertures 16 which are adapted to receive a plurality of mixing rods 18. The mixing rods 18 can be formed in one embodiment of a single length of stainless steel rod that is 1/16^{th} to ¼ inch in diameter. The mixing rod 18 has four distinct portions whereby there is an top vertical portion 19, an angled portion 20 or horizontal portion 21, a side vertical portion 22 and a bottom horizontal portion. There is a right angle between the side vertical portion 22 and the bottom portion 24. The mixing rods 18 are located equidistantly around a bottom hub 30 or threaded bottom hub 34 and the mixing device 10 can have an overall width of 1 inch to 4 inches as this allows for the mixing device 10 to be used in different scenarios and different size containers. The top vertical portions 19 are parallel to each other and are inserted into the apertures 16 in the central hub 14. An adhesive such as epoxy or glue can be used to secure the mixing rods 18 into the central hub 14 apertures 16. The apertures 16 are aligned in a circular and equidistant fashion on the bottom surface of the central hub 14 and extend a depth into the central hub 14. A pre-bent mixing rod 18 is then installed into the central hub 14 apertures 16. Each end of the mixing rod 18 will be installed into apertures 16 that are directly opposite each other. The bottom flat portion 24 of the mixing rods have a terminal end 28 that are inserted into a bottom hub 30 that is circular and disc like in shape and has an annular outer edge 31 that has apertures 32 for the insertion of the terminal ends 28 of the mixing rods 18 into the bottom hub 30. In one embodiment, the bottom hub 30 is made of aluminum and the mixing rods 18 are made of stainless steel. Due to the malleability of aluminum compared with stainless steel, insertion of the mixing rod 18 terminal end 28 into the aluminum hub locks the mixing rod 18 into the bottom hub because the steel's much harder characteristics allow the mixing rod 18 to manipulate the inner surface of the apertures 32 of the bottom hub 30 whereby said mixing rods 18 lock themselves into place without the need for an adhesive. However, in a further embodiment adhesive can be used to secure the mixing rod 18 terminal end 28 in the bottom hub 30 which allows further security during use. The flat orientation of the bottom horizontal portions 24 of the mixing rods allows for efficient mixing of the dry joint compound with water such that no waste of the dry compound occurs due to the flush contact with all flat surfaces in the bottom of the mud pan 26 and the sidewalls of the mud pan 26. The flat non-curved sides of the mixing device 10 mixing rods 18 allows the mixing device 10 to fit flush and parallel to the sides of the mud pan 26. The angled sidewalls of a typical mud pan 38 are angled outward and are narrower at the bottom of the mud pan 26 and wider at the top of the mud pan as shown in FIG. 12. This design feature allows for a drywall installer to more efficiently manipulate the drywall mud with a putty knife and it also allows an installer to easily hold the mud pan 38 at its base with one hand while they install the drywall mud onto a surface.

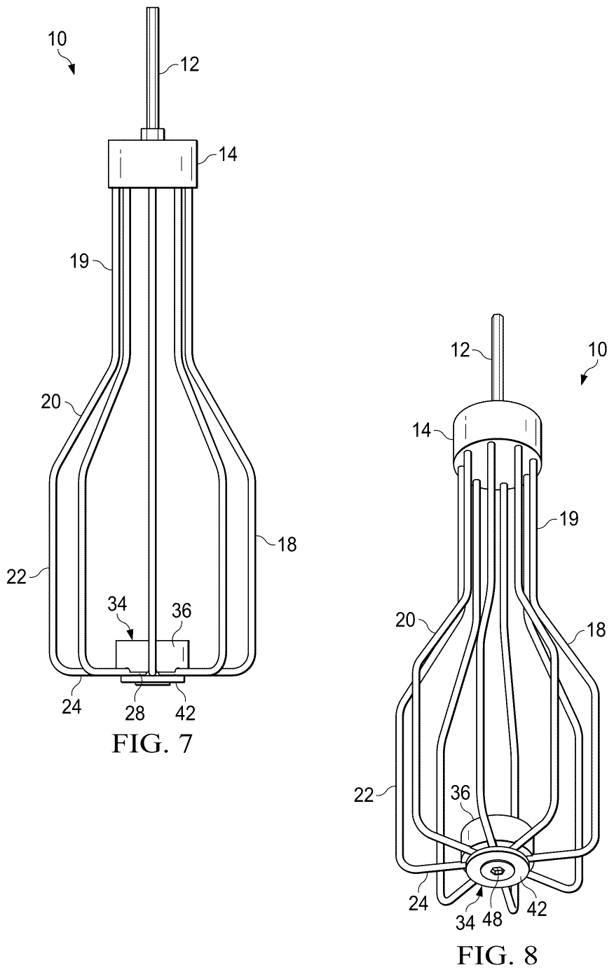

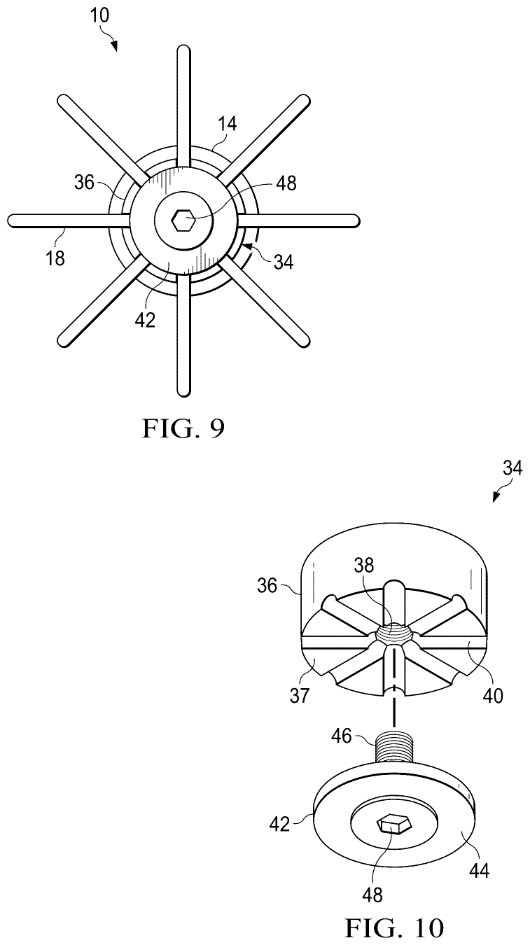

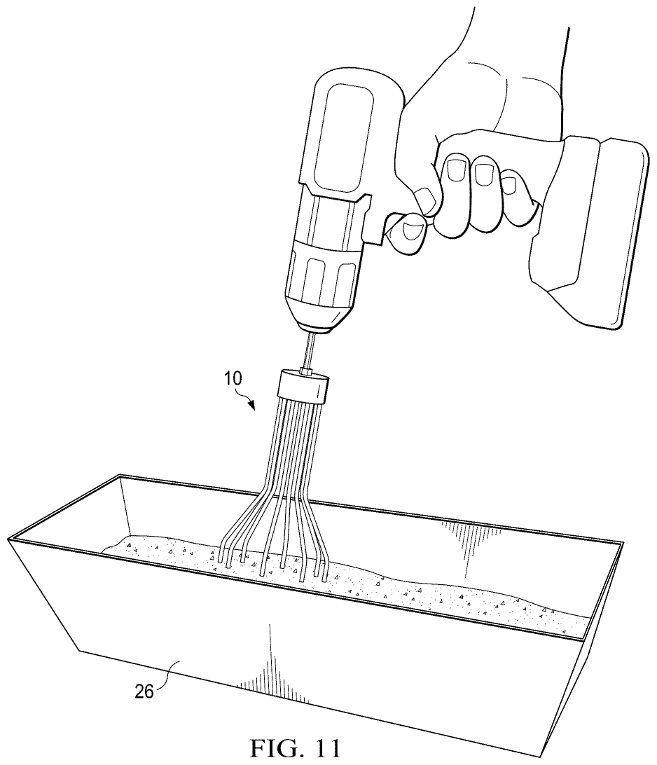

Referring now to FIGS. 7-10 there is shown one embodiment of the drywall mud mixing device 10 having a shaft 12 that is connected to a central hub 14. The shaft 12 in one embodiment is hexagonal in shape along its length and generally 1/4 inch wide. Referring to FIG. 3, located in the central hub 14 bottom surface are apertures 16 which are adapted to receive a plurality of mixing rods 18. The mixing rods 18 can be formed in one embodiment of a single length of stainless steel rod that can be 1/16^{th} to ¼ inch in diameter. The mixing rod 18 has four distinct portions whereby there is an top vertical portion 19, an angled portion 20 or horizontal portion 21, a side vertical portion 22 and a bottom horizontal portion. There is a right angle between the side vertical portion 22 and the bottom portion 24. The mixing rods 18 are located equidistantly around a bottom hub 30 or threaded bottom hub 34 and the mixing device 10 can have an overall width of 1 inch to 4 inches as this allows for the mixing device 10 to be used in different scenarios and different size containers. The top vertical portions 19 are parallel to each other and are inserted into the apertures 16 in the central hub 14. An adhesive such as epoxy or glue can be used to secure the mixing rods 18 into the central hub 14 apertures 16. The apertures 16 are aligned in a circular and equidistant fashion on the bottom surface of the central hub 14 and extend a depth into the central hub 14. A pre-bent mixing rod 18 is then installed into the central hub 14 apertures 16. Each end of the mixing rod 18 will be installed into apertures 16 that are directly opposite each other. The bottom flat portion 24 of the mixing rods have a terminal end 28 that are inserted into a threaded bottom hub 34. The threaded bottom hub 34 has a top portion 36 that has a threaded central aperture 38 and curvilinear grooves 40 on said top portion 36 bottom surface. The curvilinear grooves 40 are matched in circumference or curvature of a desired diameter mixing rod 18. The threaded bottom hub 34 has a bottom portion 42 that has a flange 44 attached to a threaded post 46. The flange has a screw or tool slot 48 on its bottom surface. In use, the threaded post 46 is inserted into the threaded central aperture 38 of the top portion 36 to a point whereby the mixing rods 18 can be installed into the curvilinear grooves 40 and against the flange 44 of the bottom portion 42 of the threaded bottom hub and the bottom portion 42 is tightened using the tool slot 48 to lock the mixing rods into place. The mixing device 10 can have a diameter of between 1 inch up to 4 inches. The diameter of the mixing rods 18 is dependent on the overall width of the mixing device 10 as a larger width mixing device 10 would require thicker and stiffer mixing rods 18 than a narrow width mixing device. Further, the mixing device 10 can have anywhere from between six to twelve mixing rods 18.

In one embodiment, the above discussed embodiments could be sold as a kit having the hexagonal shaft 12, the upper hub 14, mixing rods 18, the bottom hub 30 or the threaded bottom hub 34, and an adhesive used to secure the mixing rods 18 to the central hub 14 via said apertures 6. Producing the mixing device in kit form would allow for the horizontal stacking of the kit in a small height box, reduce the need of a manufacturer to assemble the mixing device 10, allow for ample supply on a store shelf, and allow for users and buyers to conveniently store multiple mixing devices 10 for future use after purchase. Furthermore, all components of the mixing device 10 can formed of a sturdt plastic including the shaft, central hub, mixing rods 18 and the bottom hub.

The mixing device 10 solves many problems that exist in the art with respect to mixing small quantities of drywall mud. Often times, certain projects do not require a full 5-gallon bucket of drywall mud which is a standard size in the industry but requires smaller amounts of drywall mud. Currently, small amounts of drywall that would occupy a 12 inch to 14 inch mud pan are mixed by hand with a putty knife. This is a time-consuming process and takes a competent drywall installer close to five minutes to thoroughly mix the drywall mud to a consistent and non-lumps consistency. With the mixing device 10 in accompaniment with an electric drill, the mixing process can be finished in under a minute and many times under thirty seconds. This is especially important when using quick setting drywall that cures in twenty minutes. Given that traditional mixing of drywall mud with a putty knife takes around five full minutes to achieve consistent and homogenous mixture, the mixing device 10 makes a tremendous difference on what a drywaller installer can achieve on a particular project before the quick setting drywall mix sets up in a mud pan and on a putty knife. The mixing device 10 is cleaned by inserting it into a bucket of water and hitting the power button on the electric drill. This process takes about five seconds whereas traditional putty knives or other paddle mixers must be cleaned by hand due to the angles of the surfaces inherent to the paddles such that when they are rotated in a bucket of water they do not fully get clean. A further problem with paddle mixers is they have a major tendency to throw drywall mud outside of the mixing container creating messy conditions in a living space. The disclosed mixing device 10 avoids this problem because of the circular cross-sectional shape of the mixing rods cuts right though the drywall mud with little resistance and turbulence. The flat bottom of the mixing device 10 allows for direct contact with the entire bottom of a mud pan and the square or flat sides of the mixing device 10 allows the mixing device 10 to reach cover the entire surface area of a drywall mud pan 38 such that all of the joint compound materials is mixed and the sides of the mud pan 38 left clean. In addition to drywall mud, the mixing device 10 works very well for mixing grout, concrete and paint and can be used interchangeably for these materials.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

### ENUMERATED ELEMENTS

10 mixing device
12 hexagonal shaft
14 central hub
16 apertures
18 mixing rods
19 top vertical portion
20 angled portion
21 horizontal portion
22 side vertical portion
24 bottom horizontal portion
26 mud pan
28 terminal end
30 bottom hub
31 annular outer edge
32 apertures
34 threaded bottom hub
36 top portion
37 bottom surface
38 threaded central aperture
40 curvilinear grooves
42 bottom portion
44 flange
46 threaded post
48 tool slot

What is claimed is:

1. A mixing device, comprising:
a shaft connected to a central hub;
a plurality of mixing rods connected to the central hub whereby the mixing rods each have a vertical side portion that is parallel to a sidewall of a mixing container and a bottom flat portion that is parallel with a bottom surface of a mixing container and whereby the junction of the vertical portion of the mixing rod and bottom flat portion of the mixing rod is bent at a right angle and said bottom flat portion of said mixing rods terminate into a bottom hub.

2. The mixing device of claim 1 whereby the bottom hub is comprised of a top portion that has a threaded central aperture and said bottom hub has on its bottom surface curvilinear grooves that correspond to a mixing rod bottom flat portion terminal end and a bottom portion of the bottom hub whereby said bottom portion has a flange with a threaded post whereby the threaded post is inserted into the threaded central aperture and the bottom portion of the bottom hub is tightened to lock the mixing rods between the top portion and the bottom portion of the bottom hub.

3. The mixing device of claim 2 wherein each said mixing rod is formed out of a single length of metal wire or molded plastic.

4. The mixing device of claim 3 further comprising a top vertical portion of the mixing rod that merges into an angled portion or a horizontal portion which merges into said vertical side portion.

5. The mixing device of claim 4 wherein the distance between one mixing rod vertical side portion and a second mixing rod vertical side portion located 180 degrees in relation to the first mixing rod vertical side portion can be one inch wide, 2.3-2.5 inches wide or 4 inches wide.

6. The mixing device of claim 5 wherein the mixing rods can have a diameter of 1/16 inches, 3/32 inches, ⅛ inches, 3/16 inches or ¼ inches.

7. The mixing device of claim 2 wherein the bottom hub is made of aluminum and the mixing rods are made of stainless steel.

8. The mixing device of claim 2 wherein the shaft is hexagonal and insertable into an electric drill chuck.

9. A mixing device, comprising:
a shaft connected to a central hub;
a plurality of mixing rods connected to the central hub whereby the mixing rods each have a vertical side portion that is parallel to a sidewall of a mixing container and a bottom flat portion that is parallel with a bottom surface of a mixing container and whereby the junction of the vertical portion of the mixing rod and bottom flat portion of the mixing rod is bent at a right angle and said bottom flat portion of said mixing rods terminate into a bottom hub.

10. The mixing device of claim 9 whereby the bottom hub is an aluminum metal disc that has an annular outer edge whereby ports adapted to receive said mixing rod terminal ends are located on the annular outer edge.

11. The mixing device of claim 10 wherein each said mixing rod is formed out of a single length of metal wire or molded plastic.

12. The mixing device of claim 11 further comprising a top vertical portion of the mixing rod that merges into an angled portion or a horizontal portion which then merges into said vertical side portion.

13. The mixing device of claim 12 wherein the distance between one mixing rod vertical side portion and a second mixing rod vertical side portion located 180 degrees in relation to the first mixing rod vertical side portion can be one inch wide, 2.3-2.5 inches wide or 4 inches wide.

14. The mixing device of claim 13 wherein the mixing rods can have a diameter of 1/16 inches, 3/32 inches, ⅛ inches, 3/16 inches or ¼ inches.

15. The mixing device of claim 10 wherein the bottom hub is made of aluminum, and the mixing rods are made of stainless steel.

16. The mixing device of claim 10 wherein the shaft is hexagonal and insertable into an electric drill chuck.

17. A mixing device kit, comprising:
a central hub having apertures on its bottom surface and said central hub having a hexagonal shaft installed into is top surface;
a plurality of mixing rods whereby the mixing rods have a bottom flat portion, a vertical side portion and an angled or horizontal portion that merges into a top vertical portion;
a bottom hub adapted to receive terminal ends of said mixing rods; and
an adhesive to be used to join the mixing rods to said central hub.

18. The mixing device kit of claim 17 wherein the bottom hub has an annular outer edge whereby ports adapted to receive said mixing rod terminal ends are located on the annular outer edge.

19. The mixing device kit of claim 18 wherein the distance between one mixing rod vertical side portion and a second mixing rod vertical side portion located 180 degrees in relation to the first mixing rod vertical side portion can be one inch wide, 2.3-2.5 inches wide or 4 inches wide and said mixing rods can have a diameter of 1/16 inches, 3/32 inches, ⅛ inches, 3/16 inches or ¼ inches.

20. The mixing device kit of claim 17 whereby the bottom hub is comprised of a top portion that has a threaded central aperture and said bottom hub has on its bottom surface curvilinear grooves that correspond to a mixing rod bottom flat portion terminal end and a bottom portion of the bottom hub whereby said bottom portion has a flange with a threaded post whereby the threaded post is inserted into the threaded central aperture and the bottom portion of the bottom hub is tightened to lock the mixing rods between the top portion and the bottom portion of the bottom hub.

21. The mixing device kit of claim 20 wherein the distance between one mixing rod vertical side portion and a second mixing rod vertical side portion located 180 degrees in relation to the first mixing rod vertical side portion can be one inch wide, 2.3-2.5 inches wide or 4 inches wide and said mixing rods can have a diameter of 1/16 inches, 3/32 inches, ⅛ inches, 3/16 inches or ¼ inches.
